(19) United States
(12) Patent Application Publication
(10) Pub. No.: US 2010/0236757 A1
(43) Pub. Date: Sep. 23, 2010

(54) CLEANING SYSTEM FOR A WATER-COOLED HEAT EXCHANGER

(76) Inventor: Chen-Fa Chou, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/407,317

(22) Filed: Mar. 19, 2009

(51) Int. Cl. F28G 1/12; B08B 9/04

(52) U.S. Cl. 165/95; 15/104.061

(57) ABSTRACT

A cleaning system for a water-cooled heat exchanger has a collector, a driving device, a condenser, a ball trap and multiple cleaning balls. The collector has an opening, a filtering net, three inlet holes and two outlet holes. The driving device is connected to the collector and has an outlet tube, an inlet tube and a pump. The condenser is connected to the collector and has an inlet, an outlet, multiple copper pipes, an inlet pipe and an overflow pipe. The ball trap is connected to the condenser and the collector and has an inlet end, an outlet end, an internal surface, multiple turbulent blades, an entering pipe and a discharge pipe. The cleaning balls are movably mounted in the collector, the condenser and the ball trap with the cooling water and each cleaning ball has multiple cleaning protrusions and an eccentric rib.

### BACKGROUND OF THE INVENTION

1. Field of the Invention

The present invention relates to a cleaning system, and more particularly to a cleaning system for a water-cooled heat exchanger that can improve a heat exchange efficiency of the heat exchanger.

2. Description of Related Art

A conventional heat exchanger in accordance with the prior art is used with an air condition system or a cooling system to absorb and exchange heat from a working mechanism to a coolant, such as refrigerant or a high temperature fluid to reduce the temperature of the working mechanism and may be air-cooled or water-cooled and comprises a casing storing the coolant and exchanging heat with cooling air or water.

The conventional water-cooled heat exchanger has an inlet, an outlet and a condenser. The condenser is mounted between the inlet and the outlet and has multiple copper pipes to store the cooling water to absorb heat from and cool down the working mechanism. However, limescale or dirt accumulates on the external surfaces of the copper pipes of the conventional water-cooled heat exchanger due to evaporating and condensing of the cooling water. The limescale and the dirt will block the heat exchanging action between the cooling water and the coolant. Thus, the heat transmitting efficiency of the conventional water-cooled heat exchanger is reduced.

To overcome the shortcomings, the present invention provides a cleaning system for a water-cooled heat exchanger to mitigate or obviate the aforementioned problems.

### SUMMARY OF THE INVENTION

The main objective of the present invention is to provide a cleaning system for a water-cooled heat exchanger that can improve a heat exchange efficiency of the heat exchanger.

The cleaning system for a water-cooled heat exchanger in accordance with the present invention has a collector, a driving device, a condenser, a ball trap and multiple cleaning balls. The collector has an opening, a filtering net, three inlet holes and two outlet holes. The driving device is connected to the collector and has an outlet tube, an inlet tube and a pump. The condenser is connected to the collector and has an inlet, an outlet, multiple copper pipes, an inlet pipe and an overflow pipe. The ball trap is connected to the condenser and the collector and has an inlet end, an outlet end, an internal surface, multiple turbulent blades, an entering pipe and a discharge pipe. The cleaning balls are movably mounted in the collector, the condenser and the ball trap with the cooling water and each cleaning ball has multiple cleaning protrusions and an eccentric rib.

Other objectives, advantages and novel features of the invention will become more apparent from the following detailed description when taken in conjunction with the accompanying drawings.

### BRIEF DESCRIPTION OF THE DRAWINGS

FIG. 1 is a schematic of a cleaning system for a water-cooled heat exchanger;

FIG. 2 is a top view of a collector of the cleaning system in FIG. 1:

FIG. 3 is an enlarged perspective view of a ball trap of the cleaning system in FIG. 1;

FIG. 4 is an enlarged perspective view of a first embodiment of a cleaning ball of the cleaning system in FIG. 1;

FIG. 5 is an enlarged perspective view of a second embodiment of a cleaning ball of the cleaning system in FIG. 1;

FIG. 6 is a first operational embodiment of the cleaning system in FIG. 1;

FIG. 7 is a second operational embodiment of the cleaning system in FIG. 1; and

FIG. 8 is a third operational embodiment of the cleaning system in FIG. 1.

### DETAILED DESCRIPTION OF THE PREFERRED EMBODIMENT

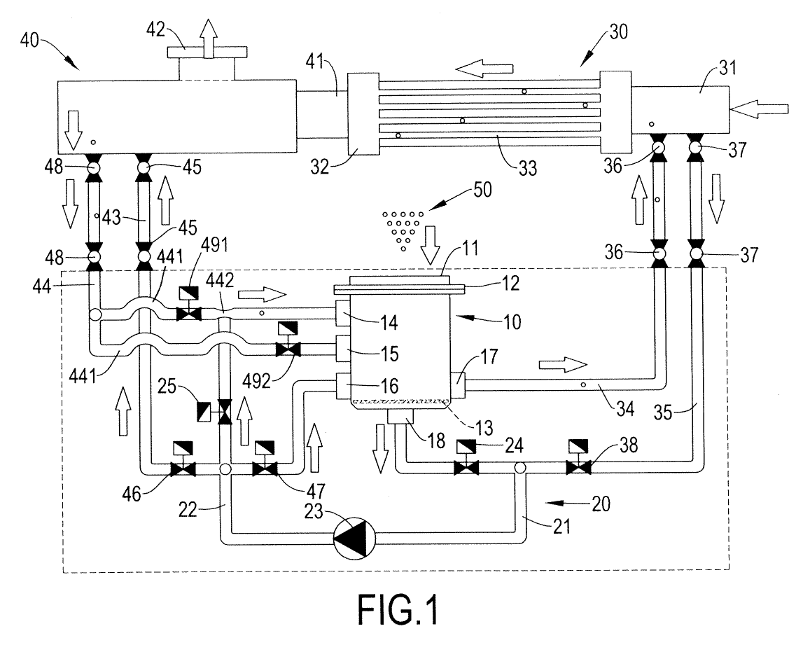

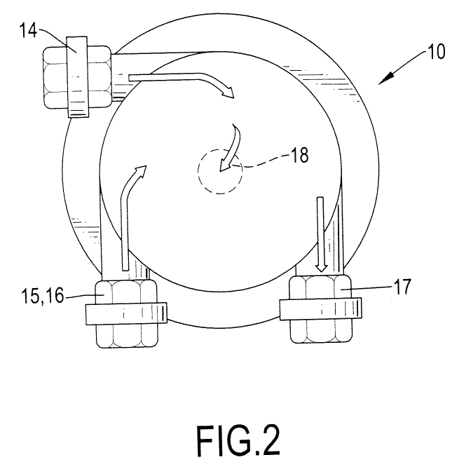

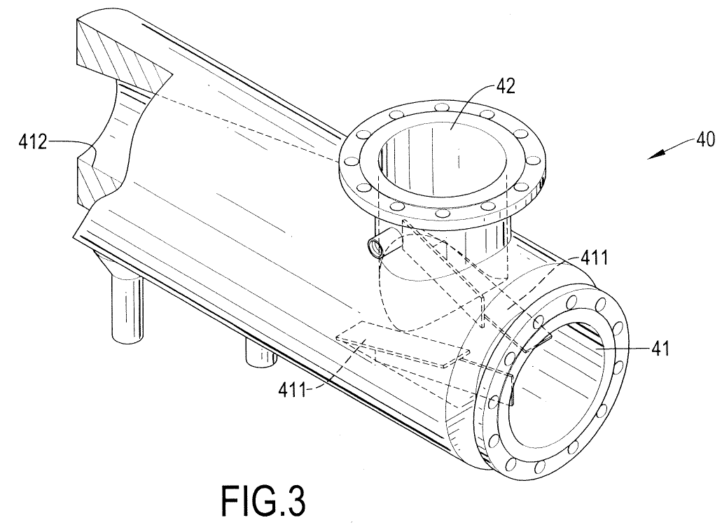

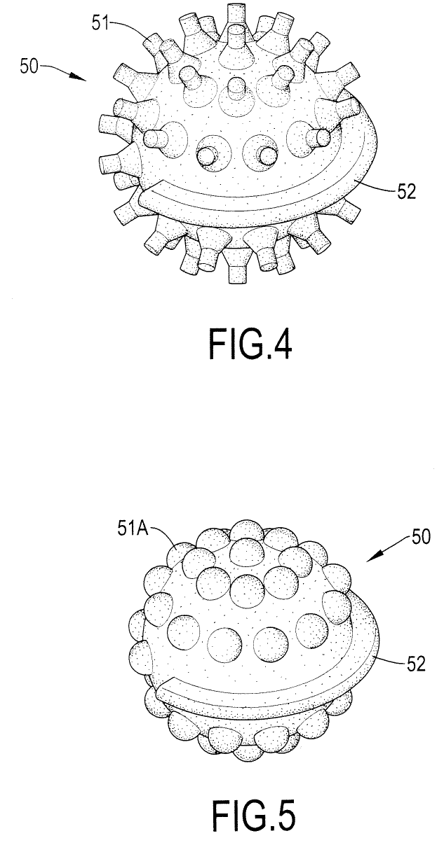

With reference to FIGS. 1 to 5, a cleaning system for a water-cooled heat exchanger in accordance with the present invention comprises a collector (10), a driving device (20), a condenser (30), a ball trap (40) and multiple cleaning balls (50).

The collector (10) may be a hollow, metal cylinder and has a top, a bottom, a chamber (not numbered), an external surface, an opening (11), a window (12), a filtering net (13), multiple inlet holes (14, 15, 16), two outlet holes (17, 18), multiple check valves (not shown) and may be filled with cooling water.

The opening (11) is formed through the top of the collector (10) and communicates with the chamber of the collector (10).

The window (12) is mounted through the top of the collector (10) to allow the chamber of the collector (10) to be viewed. The filtering net (13) may be stainless steel and is mounted in the chamber of the collector (10) near the bottom.

The inlet holes (14, 15, 16) are tangentially formed through the external surface of maybe near the top of the collector (10) and communicate with the chamber of the collector (10) and comprise a first inlet (14), a second inlet (15) and a third inlet (16). The outlet holes (17, 18) are respectively formed tangentially though the external surface and through the bottom of the collector (10) and communicate with the chamber of the collector (10). The outlets (17, 18) may be disposed relatively lower than the inlets (14, 15, 16), so the cooling water has circulating time in the container (10), and when the inlets (14, 15, 16) and one outlet (17) is tangentially formed, the cooling water flows circularly for longer circulating time. Preferably, the cooling water flows clockwise.

The check valves are mounted in the inlet holes (14, 15, 16) and outlet holes (17, 18) of the collector (10) to ensure the cooling water in the collector (10) flows in a single direction.

The driving device (20) is connected to the collector (10) between the outlet holes (17, 18) and the inlet holes (14, 15, 16) and has an outlet tube (21), an inlet tube (22), a pump (23) and two electromagnetic valves (24, 25).

The outlet tube (21) is connected to the collector (10) by the outlet hole (18) formed through the bottom of the collector (10).

The inlet tube (22) is connected to the collector (10) by the first inlet hole (14) of the collector (10).

The pump (23) is connected to the outlet tube (21) and the inlet tube (22).

The electromagnetic valves (24, 25) are respectively connected to the outlet tube (21) and the inlet tube (22) between the collector (10) and the pump (23).

The condenser (30) is connected to the collector (10) and has two ends, an inlet (31), an outlet (32), multiple copper pipes (33), an inlet pipe (34), an overflow pipe (35), multiple hand valves (36, 37), an electromagnetic valve (38) and a net (not shown).

The inlet (31) and the outlet (32) are respectively formed in the ends of the condenser (30).

The copper pipes (33) are parallelly mounted in the condenser (30) between the inlet (31) and the outlet (32).

The inlet pipe (34) is connected between the condenser (30) at the inlet (31) and the collector (10) by the outlet hole (17) formed through the external surface of the collector (10).

The overflow pipe (35) is connected to the condenser (30) at the inlet (3 1) and is connected to the outlet tube (21) of the driving device (20).

Two hand valves (36, 37) are mounted on the inlet pipe (34) between the condenser (30) and the collector (10) and two hand valves (36, 37) are mounted on the overflow pipe (35) between the condenser (30) and the collector (10).

The electromagnetic valve (38) of the condenser (10) is connected to the overflow pipe (35) between the condenser (30) and the outlet tube (21) of the driving device (20).

The net is mounted in the condenser (30) near the overflow pipe (35) to prevent the cleaning balls (50) flowing to the driving device (20).

The ball trap (40) is connected to the condenser (30) and the collector (10) and has an external surface, an inlet end (41), an outlet end (42), an internal surface (412), multiple turbulent blades (411), an entering pipe (43), a discharge pipe (44), multiple hand valves (45, 48) and multiple electromagnetic valves (46, 47, 491, 492).

The inlet end (41) of the ball trap (40) is connected to the outlet (32) of the condenser (30).

The outlet end (42) is formed in the external surface of the ball trap (40) near the inlet end (41) of the ball trap (40).

The internal surface (412) is formed in the ball trap (40) and tapers away from the inlet end (41) of the ball trap (40).

The turbulent blades (411) are obliquely formed in the ball trap (40) near the inlet end (41) to ensure movement of the cooling water and four turbulent blades (411) may be implemented.

The entering pipe (43) is connected between the external surface of the ball trap (40) and the third inlet hole (16) of the collector (10).

The discharge pipe (44) is connected to the external surface of the ball trap (40) near the internal surface (412), is connected to the collector (10) and the driving device (20) and has two branch pipes (441) and a venturi tube (442). One of the branch pipes (441) is connected to the second inlet hole (15) of the collector (10) and the other branch pipe (441) is connected to the inlet tube (22) of the driving device (20). The venturi tube (442) is connected to the driving device (20) and the discharge pipe (44) between the inlet tube (22) and the corresponding branch pipe (441).

Two hand valves (45, 48) of the ball trap (40) are connected to the entering pipe (43) between the ball trap (40) and the collector (10) and two hand valves (45, 48) of the ball trap (40) are connected to the discharge pipe (44) between the ball trap (40) and the collector (10).

Two electromagnetic valves (46, 47) of the ball trap (40) are connected to the entering pipe (43) between the ball trap (40) and the collector (10) and two electro-magnetic valves (491, 492) of the ball trap (40) are connected to the branch pipes (441) of the discharge pipe (44) between the ball trap (40) and the collector (10).

The cleaning balls (50) may be rubber, are movably mounted in the collector (10), the condenser (30) and the ball trap (40) with the cooling water and each cleaning ball (50) has a specific gravity, an external surface, multiple cleaning protrusions (51, 51A) and an eccentric rib (52). The specific gravity of the cleaning ball (50) is larger than or equal to specific gravity of the cooling water.

The cleaning protrusions (51, 51A) may be conical or hemispherical shaped and are formed on and protrude from the external surface of the cleaning ball (50) to knock and rub against the internal surfaces of the copper pipes (33) of the condenser (30) to wipe off limescale or dirt that has accumulated on the internal surfaces of the copper pipes (33).

The eccentric rib (52) may be C-shaped and is formed on and protrudes from the external surface of the cleaning ball (50) between the cleaning protrusions (51, 51A) to make the cleaning ball (50) rotate eccentrically in the cooling water.

The cleaning system for a water heat exchanger in accordance with the present invention has two cleaning operations: a signal loop cleaning operation and a double loop cleaning operation.

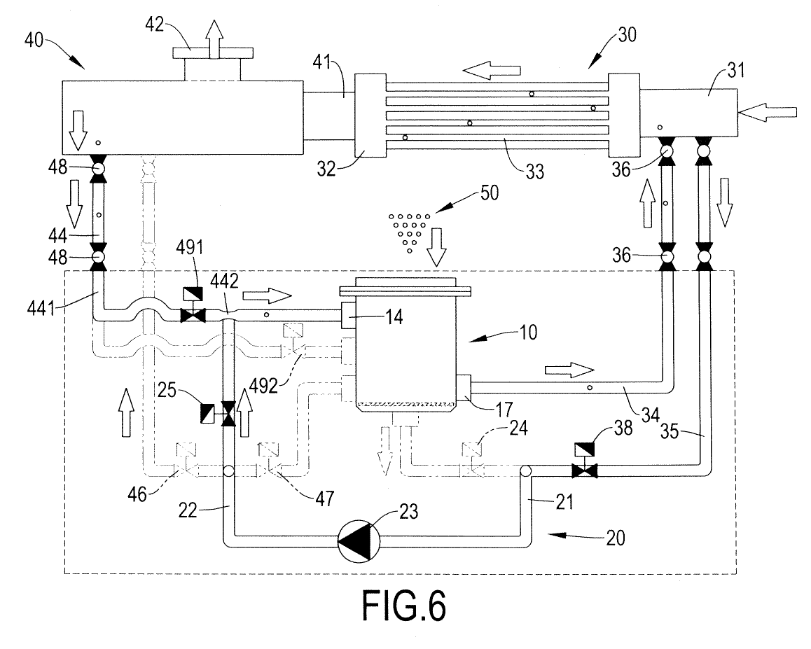

With further reference to FIG. 6, when limescale or dirt has accumulated on the internal surfaces of the copper pipes (33) of the condenser (30), the signal loop cleaning loop is operated the electromagnetic valves (38, 25, 491) of the overflow pipe (35) of the condenser (30), the inlet tube (21) of the driving device (20) and the branch pipe (441) of the discharged pipe (44) connected to the venturi tube (442) are opened and the electromagnetic valves (24, 46, 47, 492) of the outlet tube (21) of the driving device (20), the entering pipe (43) of the ball trap (40) and the other branch pipe (441) of the discharged pipe (44) are closed. Therefore, the cooling water in the inlet (31) of the condenser (30) flows) via the overflow pipe (35) to the pump (23) to be pressurized and transported to the chamber of the collector (10) via the inlet tube (22) of the driving device (20) and the first inlet hole (14) of the collector (10).

When the cooling water flows into the chamber of the collector (10) by the pump (23), the cleaning balls (50) in the chamber of the collector (10) will move with the cooling water in the copper pipes (33) of the condenser (30) via the outlet hole (17) formed on the external surface of the collector (10), the inlet pipe (34) and the hand valves (36) of the condenser (30). When the cleaning balls (50) flow into the copper pipes (33) with the cooling water, the eccentric ribs (52) of the cleaning balls (50) provide an eccentric and rotatable effect to the cleaning balls (50) so the cleaning protrusions (51, 51A) formed on the external surface of the cleaning balls (50) knock and rub against the internal surfaces of the copper pipes (33) of the condenser (30) to wipe off limescale or dirt that has accumulated on the internal surfaces of the copper pipes (33).

After the cleaning balls (50) have cleaned the internal surfaces of the copper pipes (33), the cleaning balls (50) will flow into the ball trap (40) with the cooling water via the outlet (32) of the condenser (30), and the venturi tube (442) connected to the corresponding branch pipe (441) of the discharge pipe (44) will form low pressure suction according to Bernoulli's Law to suck the cleaning balls (50) to the collector (10) via the hand valves (48) and the electromagnetic valve (491) of the discharge pipe (44) and the first inlet hole (14) of the collector (10). The signal loop cleaning of the cleaning system in accordance with the present invention can make the cleaning balls (50) continuously flow with the cooling water between the collector (10), the condenser (30) and the ball trap (40) and clean the internal surfaces of the copper pipes (33) in a short time.

When limescale or dirt that has accumulated on the internal surfaces of the copper pipes (33) of the condenser (30) has been cleaned by the above-mentioned signal loop cleaning of the cleaning system, the double loop cleaning of the cleaning system in accordance with the present invention can be operated and includes three steps: a sending step, a receiving step and a waiting step.

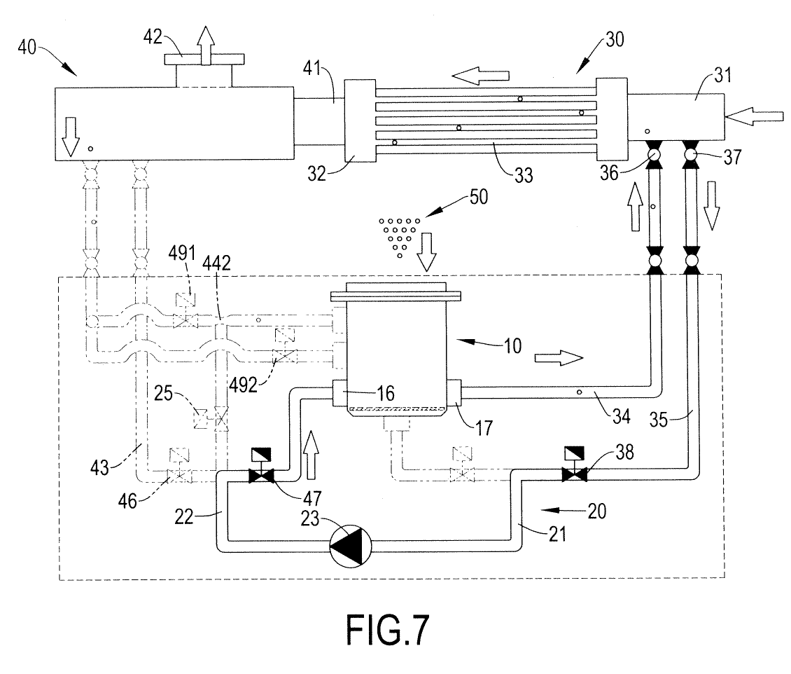

With reference to FIG. 7, in the sending step, opening the electro-magnetic valves (47, 38) of the entering pipe (43) close to the third inlet hole (16) of the collector (10) and the overflow pipe (35) of the condenser (30) and the hand valves (36, 37) of the inlet pipe (34) and the overflow pipe (35) of the condenser (30), and closing the electromagnetic valves (25, 46, 492) of the inlet tube (22) of the driving device (20), the entering pipe (43) far from the third inlet hole (16) of the collector (10) and the branch pipe (441) of the discharge pipe (44) that is not connected to the venturi tube (442). Then, pumping the cooling water to flow into and out of the collector (10) via the third inlet hole (16) and the outlet hole (17) formed on the external surface of the collector (10) and flow in the cooper pipes (33) of the condenser (30) via the inlet pipe (34) and the inlet (31) of the condenser (30). When the cooling water flows out of the collector (10) and flows into the condenser (30), the cleaning balls (50) will move with the cooling water to wipe off limescale or dirt that has accumulated on the internal surfaces of the copper pipes (33).

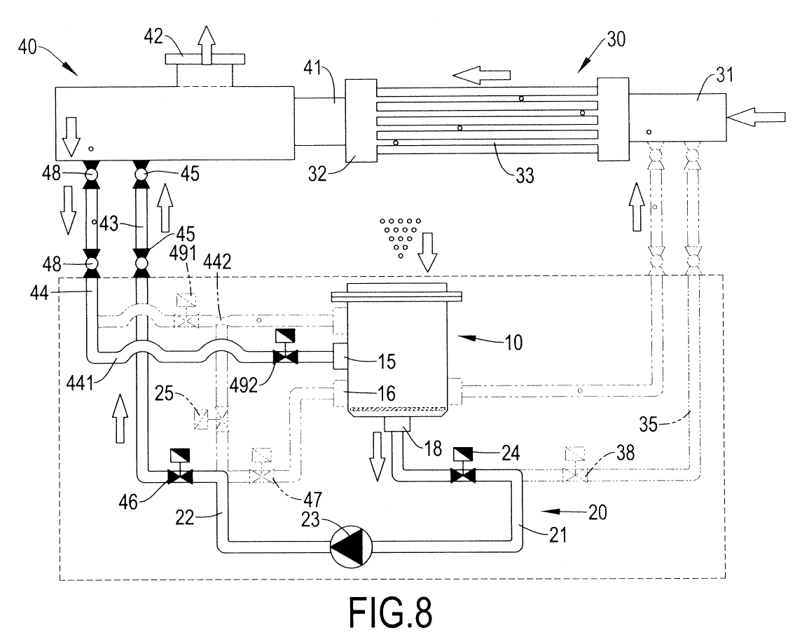

With further reference to FIG. 8, after the sending step, the receiving step is actuated by opening the electromagnetic valves (24, 46, 492) of the outlet tube (21) of the driving device (20), the entering pipe (43) far from the third inlet hole (16) of the collector (10) and the branch pipe (441) of the discharge pipe (44) that is not connected to the venturi tube (442), and closing the electromagnetic valves (25, 38, 491, 47) of the inlet tube (22) of the driving device (20), the overflow pipe (35) of the condenser (30), the branch pipe (441) of the discharge pipe (44) that is connected to the venturi tube (442) and the entering pipe (43) that is close to the third inlet hole (16) of the collector (10). Then, the cleaning balls (50) that move with the cooling water will flow and be trapped in the outlet end (42) of the ball trap (40) by the design of the turbulent blades (411) and the converged internal surface (412) of the ball trap (40). When the cleaning balls (50) are trapped in the outlet end (42) of the ball trap (40), the pump (23) of the driving device (20) will pump the cooling water from the collector (10) into the ball trap (40) via the inlet tube (22) of the driving device (20), the entering pipe (43) and the hand valves (45) of the ball trap (40) to make the collector (10) in a negative pressure condition relative to the ball trap (40). Then, the cleaning balls (50) in the outlet end (42) of the ball trap (40) will flow back with the cooling water in the collector (10) via the hand valves (48) and the branch pipe (441) that is not connected to the venturi tube (442) of the discharge pipe (44).

In the waiting step, when all the cleaning balls (50) are collected in the collector (10) after the receiving step, turning off the pump (23) of the driving device (20) to reduce the energy consumption of the cleaning system.

The cleaning system for a water heat exchanger in accordance with the present invention has the following advantages.

1. The cleaning system for a water heat exchanger can clean limescale and dirt on the condenser (30) with the cleaning protrusions (51, 51A) of the cleaning balls (50) to clean the internal surfaces of the copper pipes (33) and improve the heat transmit efficiency of the water heat exchanger.

2. The cleaning system for a water heat exchanger has two cleaning operations: a signal loop cleaning and a double loop cleaning, which can be selected for more intensive cleaning or saving energy.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A cleaning system for a water-cooled heat exchanger having
a collector having
a top;
a bottom;
a chamber;
an external surface;
an opening being formed through the top of the collector and communicating with the chamber of the collector;
a filtering net being mounted in the chamber of the collector near the bottom;
multiple inlet holes being formed through the external surface of the collector and communicating with the chamber of the collector; and
two outlet holes being formed though the external surface and the bottom of the collector and communicating with the chamber of the collector;
a driving device being connected to the collector and having
an outlet tube being connected to the collector by the outlet hole formed through the bottom of the collector;
an inlet tube being connected to the collector by one of the inlet holes of the collector; and
a pump being connected to the outlet tube and the inlet tube;
a condenser being connected to the collector and having
two ends;
an inlet and an outlet being respectively formed at the ends of the condenser;
multiple copper pipes being parallelly mounted in the condenser between the inlet and the outlet of the condenser;
an inlet pipe being connected between the condenser at the inlet and the collector by the outlet hole; and
an overflow pipe being connected to the condenser at the inlet and being connected to the outlet tube of the driving device;
a ball trap being connected to the condenser and the collector and having
an external surface;
an inlet end being connected to the outlet of the condenser;
an outlet end being formed in the external surface of the ball trap near the inlet end of the ball trap;
an entering pipe being connected between the external surface of the ball trap and one of the inlet holes of the collector; and
a discharge pipe being connected to the external surface of the ball trap, the collector and the driving device and having two branch pipes and one of the branch pipes being connected to one of the inlet holes of the collector and the other branch pipe being connected to the inlet tube of the driving device; and
multiple cleaning balls being movably mounted in the collector, the condenser and the ball trap with the cooling water and each cleaning ball having
an external surface; and
multiple cleaning protrusions being formed on and protruding from the external surface of the cleaning ball.

2. The cleaning system as claimed in claim 1, wherein
the inlet holes of the collector have
a first inlet hole being connected to the inlet tube;
a second inlet hole being connected to a corresponding branch pipe of the discharge pipe; and
a third inlet hole being connected to the entering pipe.

3. The cleaning system as claimed in claim 2, wherein
the driving device has two electromagnetic valves being respectively connected to the outlet tube and the inlet tube between the collector and the pump;
the condenser has
multiple hand valves comprising two hand valves being mounted on the inlet pipe between the condenser and the collector and two hand valves being mounted on the overflow pipe between the condenser and the collector; and
an electromagnetic valve being connected to the overflow pipe between the condenser and the outlet tube of the driving device; and
the ball trap has
multiple hand valves, comprising two hand valves being connected to the entering pipe between the ball trap and the collector and two hand valves being connected to the discharge pipe between the ball trap and the collector; and
multiple electro-magnetic valves, having two electromagnetic valves of the ball trap being connected to the entering pipe between the ball trap and the collector and two electromagnetic valves of the ball trap being connected to the branch pipes of the discharge pipe between the ball trap and the collector.

4. The cleaning system as claimed in claim 3, wherein
the inlet holes are tangentially formed through the external surface of the collector; and
the outlet hole is tangentially formed through the external surface of the collector, whereby the cooling water flows around the container with a circulating time.

5. The cleaning system as claimed in claim 4, wherein the ball trap has multiple turbulent blades being obliquely formed in the ball trap near the inlet end.

6. The cleaning system as claimed in claim 5, wherein four turbulent blades are formed in the ball trap.

7. The cleaning system as claimed in claim 6, wherein each cleaning ball has an eccentric rib being formed on and protruding from the external surface of the cleaning ball between the cleaning protrusions.

8. The cleaning system as claimed in claim 7, wherein each cleaning ball has a specific gravity being larger than or equal to specific gravity of cooling water.

9. The cleaning system as claimed in claim 8, wherein the ball trap has an internal surface formed in the ball trap and tapering away from the inlet end of the ball trap.

10. The cleaning system as claimed in claim 9, wherein the discharge pipe of the ball trap has a venturi tube being connected to the driving device and the discharge pipe between the inlet tube and the corresponding branch pipe.

11. The cleaning system as claimed in claim 10, wherein the collector has a window being mounted through the top of the collector.

12. The cleaning system as claimed in claim 1 1, wherein the collector is a hollow metal cylinder.

13. The cleaning system as claimed in claim 12, wherein each cleaning ball is rubber.

14. The cleaning system as claimed in claim 13, wherein
the filtering net of the collector is made of stainless steel; and
the eccentric rib of each cleaning ball is C-shaped.

15. The cleaning system as claimed in claim 14, wherein each cleaning protrusion of the cleaning ball is conical shaped.

16. The cleaning system as claimed in claim 14, wherein each cleaning protrusion of the cleaning ball is hemispherical shaped.

17. The cleaning system as claimed in claim 1, wherein
the inlet holes are tangentially formed through the external surface of the collector;
the outlet hole is tangentially formed through the external surface of the collector, whereby the cooling water flows around the container in a circulating time;
the ball trap has multiple turbulent blades being obliquely formed in the ball trap near the inlet end; and
each cleaning ball has
an eccentric rib being formed on and protruding from the external surface of the cleaning ball between the cleaning protrusions; and
a specific gravity being larger than or equal to the specific gravity of a cooling water.

18. The cleaning system as claimed in claim 1, wherein
the ball trap has an internal surface being formed in the ball trap and tapering away from the inlet end of the ball trap;
the discharge pipe of the ball trap has a venturi tube being connected to the driving device and the discharge pipe between the inlet tube and the corresponding branch pipe; and
the collector has a window being mounted through the top of the collector.

19. The cleaning system as claimed in claim 1, wherein each cleaning protrusion of the cleaning ball is conical shaped.

20. The cleaning system as claimed in claim 1, wherein each cleaning protrusion of the cleaning ball is hemispherical shaped.
